(19) United States
(12) Patent Application Publication
(10) Pub. No.: US 2005/0205202 A1
(43) Pub. Date: Sep. 22, 2005

(54) Continuous lamination of RFID tags and inlets

(75) Inventors: Sam M. Chaoui, Diamond Bar, CA (US); Ozzie Penuela, Santa Clarita, CA (US)

Correspondence Address: KELLY LOWRY & KELLEY, LLP, 6320 CANOGA AVENUE, SUITE 1650, WOODLAND HILLS, CA, 91367, US

(73) Assignee: Precision Dynamics Corporation

(21) Appl. No.: 11/126,426

(22) Filed: May 10, 2005

Related U.S. Application Data
(63) Continuation-in-part of application No. 10/396,586, filed on Mar. 24, 2003.

(51) Int. Cl. B32B 31/00

(52) U.S. Cl. 156/269

(57) ABSTRACT

A process for continuous lamination of radio frequency identification (RFID) tags includes providing a continuous source of RFID inlets. The RFID inlets are dispensed between top and bottom substrates of web material which are attached to each other to create a continuous multi-layer substrate which is then formed into a dispensing configuration.

### RELATED APPLICATION

This is a continuation-in-part of U.S. patent application Ser. No. 10/396,586, filed on Mar. 24, 2003.

### BACKGROUND OF THE INVENTION

This present invention relates to identification tags which are widely used in a variety of applications. More particularly, the present invention relates to tags with radio frequency identification (RFID) inlets.

Identification tags, such as bracelets, are commonly utilized in crowd control contexts such as amusement parks, ski lifts, and rock concerts. They are applied to the wrists of the persons visiting the amusement park, utilizing the ski lift, or attending the concert in order to identify the customer and prevent various abuses which arise where large numbers of individuals congregate.

Identification bracelets have also been used in hospital or medical clinics. Initially, such bracelets were confined to providing the bare minimum of the patient's name and, possibly, the patient's illness. In crowd control situations, the bracelet was utilized to indicate the admissibility of the individual wearing the bracelet and, frequently, the duration, by color indication, of the attendance period of the person wearing the wristband. For instance, the bracelet for a concert can incorporate visually perceptible information regarding seat assignments; for amusement parks, the number of rides to which the individual is entitled; and, for ski lifts, the numbers of lifts and the numbers of rides to which the individual is entitled

Various types of prior art bracelets have been utilized in the above-mentioned situations, including bracelets fabricated from plastic sheet materials such as vinyl and various forms of plastic reinforced papers wherein the cellulosic content of the papers is bonded and strengthened by the plastic binder.

Some prior art bracelets include electronic information receptor means, such as magnetic strips or the like, and the information is imparted to the magnetic strip by corresponding electronic information conveyors. Additional or alternative information regarding the extension of credit or spending limit available to an individual may be incorporated in the information imparted to the bracelet. Other bracelets incorporate bar coding as a method of conveying information regarding the individual and the extent of his purchases. A bar code reader may be used to ‘read’ the bracelet and pull up information regarding the wearer of the bracelet from a main database containing information about the wearer of the bracelet such as name, room number, duration of stay, extension of credit or spending limit available.

RFID circuitry has been incorporated into bracelets. For example, Mosher, Jr., U.S. Pat. No. 5,973,600, the contents of which are incorporated herein, teaches a wristband that incorporates RFID identification circuitry. However, the process described requires that the RFID circuitry be fabricated during the process of making the RFID wristband. A drawback to fabricating the RFID circuitry during the process of making an RFID wristband is that errors, such as misalignment, in laying down the circuitry on the bracelet can slow or even halt production. If the circuitry equipment is misaligned such that the circuitry is not properly overlayed on the bracelet, the production line must be shut down until the error is corrected. There is a need for an RFID bracelet manufacturing process that minimizes the chance that any one part of the manufacturing process may slow down overall production.

Another patent, Mitchell et. al., U.S. Pat. No. 6,520,544, teaches a manufacturing process for labels that incorporate RFID identification circuitry where the RFID inlets are prefabricated. The prefabricated RFID inlets are individually removed from the supply web and individually placed on the laminate substrate. A drawback to this method of placement is that the system may become out of sync and the RFID inlets may not align with markings or a predetermined pattern on the laminate substrate. The process requires continuous monitoring and fine tuning to assure that the RFID inlets a placed properly with respect to the intended label pattern, which may slow down or even halt production. There is a need for an RFID tag manufacturing process that removes the need for monitored alignment of the RFID inlets, thereby minimizing the chance that any one part of the manufacturing process may slow down overall production.

Accordingly, there is a need for an even more efficient and cost-effective method of making RFID tags. The present invention fulfills these needs and provides other related advantages.

### SUMMARY OF THE INVENTION

The present invention resides in a process for continuous lamination of RFIDs tags. The manufacture of RFID tags from continuous rolls of spaced-apart, pre-fabricated RFID inlets (i.e., chip and antenna) provides an efficient and cost-effective method of making RFID tags.

A process for continuous lamination of radio frequency identification (RFID) tags includes providing a continuous source of RFID inlets. The continuous source of RFID inlets is pre-fabricated with the individual RFID inlets positioned on the source substrate in a pattern according to a pre-determined size and shape of tag. The RFID inlets may be dispensed between top and bottom substrates of web material separate from the source substrate or the source substrate may be dispensed between top and bottom with the RFID inlets still attached. In either form, the top and bottom substrates are attached to each other to create a continuous multi-layer substrate which is then formed into a dispensing configuration.

As part of the process, indicia may be printed upon a surface of the continuous multi-layer substrate. Electronically imparted information may also be applied to the RFID inlets of the continuous multi-layer substrate.

One or more of the RFID inlets may be dispensed in parallel. Dispensing of the RFID inlets may include removing at least one RFID inlet from the continuous source and placing the at least one RFID inlet on a top surface of the bottom substrate. Alternatively, the at least one RFID inlet along with the source substrate may be dispensed between the top and bottom substrates. The RFID inlets may be sealed between the top and bottom substrates by heat sealing the top and bottom substrates together. Alternatively, an adhesive coating may be placed on at least one of the top and bottom substrates with the RFID inlets placed on the adhesive coating and then the adhesive coating sealing the top and bottom substrates together.

During the inventive process, the continuous multi-layer substrate may be separated into a plurality of discrete multi-layer sections of predetermined length and shape. The plurality of discrete multi-layer sections are then formed into the dispensing configuration. A plurality of the RFID inlets may be dispensed sequentially with the RFID inlets spaced apart based on the predetermined length and shape of the discrete multi-layer sections. The discrete multi-layer sections are arranged end-to-end. When the plurality of discrete multi-layer sections comprise at least two pairs of tags in parallel, the pairs of tags are arranged end-to-end. The continuous multi-layer substrate may be separated into the plurality of discrete multi-layer sections by die-cutting the continuous multi-layer substrate. Each discrete multi-layer section may include a removable layer in order to form a label.

The dispensing configuration may comprise various forms including, but not limited to, a roll, a stack or the like. Furthermore, the roll or stack may be in various forms including, but not limited to, strips, sheets or the like. Additionally, these strips or sheets may comprise tags of various forms including, but not limited to, bracelets, labels or the like. If the continuous substrate is not differentiated into discrete sections during the claimed process, the dispensing configuration may be separated into discrete multilayer sections by an end-user.

For example, in one embodiment where the dispensing configuration is a roll, the roll of continuous substrate comprises a continuous roll of a plurality of strips. The plurality of strips may correspond to the plurality of discrete sections. Each discrete section may comprise at least one bracelet and may further include at least two pairs of bracelets in parallel which may be arranged end-to-end. Each discrete section may also comprise at least one label and may include at least two pairs of labels in parallel which may be arranged end-to-end.

In another embodiment, the roll of continuous substrate comprises a continuous roll of a plurality of sheets. The plurality of sheets may correspond to the plurality of discrete sections. Each discrete section may comprise at least one bracelet and may further include at least two pairs of bracelets in parallel which may be arranged end-to-end. Each discrete section may also include at least one label and may include at least two pairs of labels in parallel which may be arranged end-to-end.

In yet another embodiment, the dispensing configuration comprises a stack (i.e., a stack which may or may not comprise a fan-folded stack), the stack comprising a continuous stack of a plurality of strips. The plurality of strips may correspond to the plurality of discrete sections. Each discrete section comprises at least one bracelet and may further include at least two pairs of bracelets in parallel which may be arranged end-to-end. Each discrete section may also include at least one label and may further include at least two pairs of labels in parallel which may be arranged end-to-end.

In another embodiment, the stack comprises a continuous stack of a plurality of sheets. The plurality of sheets may correspond to the plurality of discrete sections. Each discrete section includes at least one bracelet which may further include at least two pairs of bracelets in parallel which may be arranged end-to-end. Likewise, each discrete section may include at least one label which further include at least two pairs of labels in parallel which may be arranged end-to-end.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic view illustrating a process of laminating RFID bracelets in accordance with one embodiment of the present invention;

FIG. 2 illustrates a continuation of the process of FIG. 1;

FIG. 3 illustrates an alternative embodiment of the process of laminating RFID bracelets;

FIG. 4. illustrates a continuation of the process of FIG. 3;

FIG. 5 illustrates a web substrate with regions of small slits;

FIG. 6 is a cross-sectional view of a strip formed by an RFID substrate and a bottom substrate;

FIGS. 7 and 8 illustrate, respectively, top plan and cross-sectional views of an RFID label produced by the processes of FIGS. 1 and 3, wherein the cross-section is taken along line 8-8 of FIG. 7;

FIG. 9 illustrates the process of laminating RFID bracelets in accordance with an additional embodiment of the present invention resulting in a stacked dispensing configuration;

FIG. 10 illustrates another alternative embodiment of the process of laminating RFID tags resulting in a rolled dispensing configuration;

FIG. 11 illustrates yet a another embodiment of the process of laminating RFID tags resulting in a stacked dispensing configuration; and

FIG. 12 illustrates an additional embodiment of the process of laminating RFID tags resulting in a rolled dispensing configuration.

### DETAILED DESCRIPTION OF THE PREFERRED EMBODIMENTS

The present invention resides in a process for continuous lamination of radio frequency identification (RFID) tags. The manufacture of RFID tags from continuous rolls of pre-arranged, pre-fabricated RFID inlets provides an efficient and cost-effective method of making RFID tags. The process for continuous lamination of RFID tags includes a continuous lamination process of placing at least one RFID inlet between two substrates (i.e., a top substrate and a bottom substrate) made of plastic sheets or rolls of web. A continuous source of pre-arranged, pre-fabricated RFID inlets is provided. The RFID inlets on the continuous source of pre-arranged, pre-fabricated RFID inlets are spaced apart based upon a predetermined size and shape of tag.

The present invention permits the use of pre-fabricated RFID inlets manufactured by any technique known in the art, including but not limited to, printing of organic materials or traditional masking and etching techniques. With regard to fabrication of RFID inlets, the present invention reduces and/or eliminates the drawbacks associated with fabricating the RFID circuitry during the process of manufacturing the RFID tag. Therefore, the chances are minimized that the overall production will be slowed down due to errors in fabricating the RFID circuitry. With regard to the arrangement and/or placement of RFID inlets on a laminate substrate during the manufacture of RFID tags, the present invention eliminates the need to register or align the RFID inlets with pre-printed indicia on the laminate substrate. Therefore, the chances are minimized that the overall production will be slowed down due to errors in arranging and/or placing the RFID inlets on the laminate substrate.

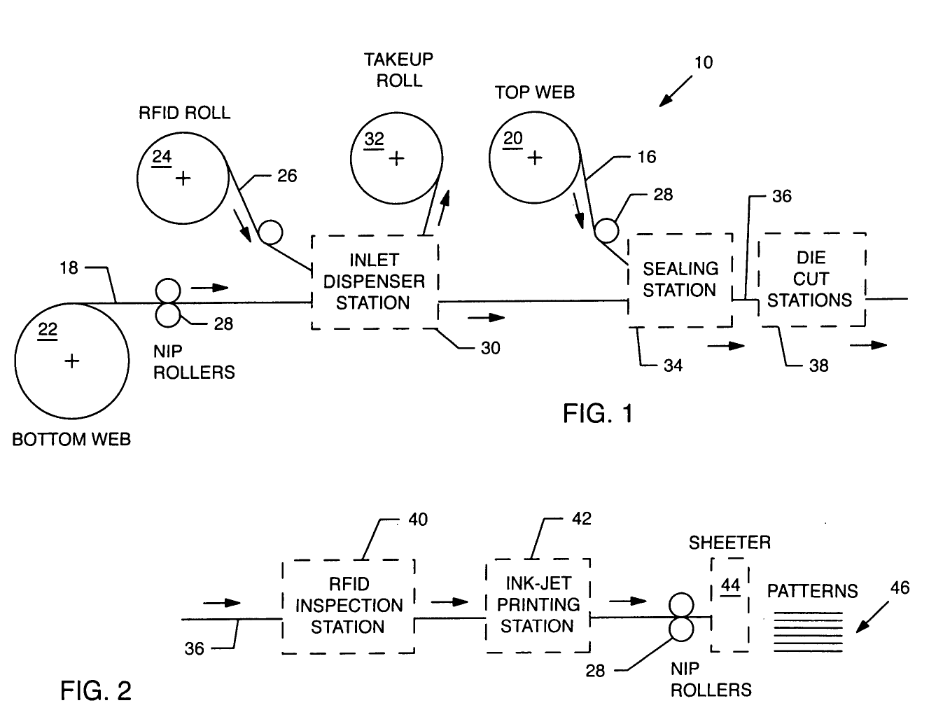

As illustrated in FIGS. 1, 2 and 5, a continuous lamination apparatus 10 incorporates a process that manufactures RFID bracelets 12, such as labels and/or bracelets, by placing at least one RFID inlet 14 between two layers or substrates (i.e., a top substrate 16 and a bottom substrate 18). The RFID inlet 14 may be of a read only, read/write, passive, or active configuration. The substrates 16, 18 may be made of an engineering thermoformed plastic in the form of respective sheets or rolls 20, 22 of web material that may include polyester, a low-density polyethylene and the like. This process sandwiches the RFID inlet(s) 14 between the top and bottom substrates 16, 18 of web material.

The RFID inlets 14 are pre-arranged and pre-fabricated in a roll form 24 on a substrate 26. The RFID inlets 14 may be separated from the substrate 26 and placed between the substrates 16, 18 or the substrate 26 may be placed between the substrates 16, 18 along with the RFID inlets 14. The RFID inlets 14 are pre-arranged on the substrate 26 according to a predetermined size and shape of tag and pattern of dispensing, i.e., single, pairs, quads, end-to-end, parallel, etc. The pre-arrangement of the RFID inlets 14 on the substrate 26 controls the pattern in which the RFID inlets 14 are placed between the substrates 16, 18, thereby eliminating the need to align and/or register the RFID inlet 14 with a pattern or indicia on the substrates 16, 18.

The RFID inlet substrate 26 and substrates 16, 18 are shown following a generally lineal path through the apparatus 10. In the interests of space economy, a more circuitous path may be followed as required by geometry and placement of the elements of the apparatus 10.

Juxtaposed to the lineal path of the RFID inlet substrate 26 and substrates 16, 18 is a translating means (not shown). The translating means includes a number of nip or drive rollers 28 positioned along the apparatus 10 in order to move the RFID inlet substrate 26 and substrates 16, 18 along from station to station. These drive rollers 28 frictionally engage with the surfaces of the RFID inlet substrate 26, as well as the top and bottom substrates 16, 18, frictionally driving the substrates 16, 18, 26 through the apparatus 10.

The drive roller 28 may be rotated by an electric motor or similar means, but it is preferable that a stepper motor or the like be utilized in the apparatus 10 because the process of the invention may require that the RFID inlet substrate 26 and substrates 16, 18 be halted intermittently for purposes to be discussed in greater detail below. The speed of the stepper motor may be regulated by suitable control means (not shown) in order to control the translation of the RFID inlet substrate 26 and substrates 16, 18 through the apparatus 10 and control the length of the dwell times necessitated by the process of the invention.

The process begins with the roll 24 of RFID inlet substrate 26 having pre-arranged, pre-fabricated RFID inlets 14. As discussed above, the roll 24 may have repeated single or side-by-side multiples of RFID inlets 14 placed sequentially one-after-the-other. It is preferable that the RFID inlets 14 be arranged depending on the predetermined size and shape of the bracelets 12. The length of roll 24 is then supplied as needed. Alternatively, the RFID inlet substrate 26 and substrates 16, 18 may be provided in a fan-folded stack or other configurations and dispensed from a suitable receptacle with the RFID inlet substrate 26 retaining the characteristic of pre-arranged, pre-fabricated RFID inlets 14. The substrates 16, 18, 26 may be in the form of strips, sheets, or the like.

An inlet dispenser station 30 accommodates the substrate 26 holding the RFID inlets 14 and bottom substrate 18. The inlet dispenser station 30 may remove an RFID inlet 14 from the substrate 26 and place the RFID inlet 14 on a top surface of the bottom substrate 18. Such removal may be performed mechanically or through physical force exerted by an adhesive or similar material on the surface of the substrate 18 as will be discussed below. A takeup roll 32 may be used to collect the substrate 26 from which the RFID inlets 14 have been removed. The pre-fabricated RFID inlets 14 are placed on the bottom substrate 18 in the pre-arranged pattern according to the predetermined size and shape of bracelet 12 as discussed above. Alternatively, the pre-fabricated RFID inlets 14 may be introduced without the roll 24 of substrate 26 and either hand or machine positioned on the bottom substrate 18.

The bottom substrate 18 including the RFID inlets 14 is moved into a sealing station 34. The top substrate 16 is also moved into the sealing station 34. The top and bottom substrates 16, 18 may then be laminated or sealed together as one continuous substrate 36, either through a heat-sealing process using a heated die or by using an adhesive coating between the substrates 16, 18 to hold the substrates 16, 18 together. The top and bottom substrates 16, 18 may be transparent, translucent, colored in solid colors or multi-color decorative patterns. For example, both top and bottom substrates 16, 18 may be blue in color. In another example, one of the substrates 16, 18 may be blue while the other substrate may be red. In yet another example, the substrates may be covered with holiday patterns (e.g., Christmas, Chanukah, Fourth of July, Halloween, etc.).

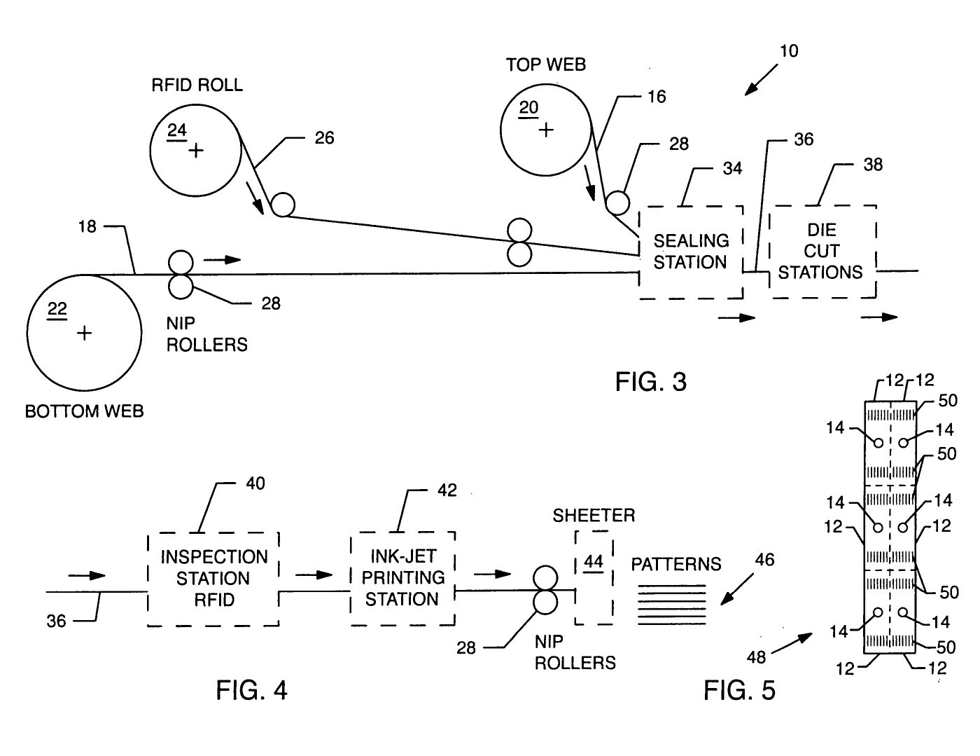

As illustrated in FIGS. 3, 4 and 5, a continuous lamination apparatus 10 incorporates an alternative process that manufactures RFID bracelets 12 by eliminating the dispenser station 30 and directly laminating or sealing together all three substrates (i.e., RFID inlet substrate 26, top substrate 16, bottom substrate 18) as one continuous substrate 36, either through a heat-sealing process using a heated die or by using an adhesive coating.

As outlined above, the RFID inlets 14 on the RFID inlet substrate 26 are pre-fabricated and may be of a read only, read/write, a passive, or an active configuration. The substrates 16, 18, 26 may be made of the same materials as described above. In a preferred embodiment, this process sandwiches the RFID substrate 26 between the top and bottom substrates 16, 18 of web material. The RFID substrate 26 is placed between the substrates 16, 18 and the RFID inlets 14 are thereby positioned in the pre-arranged pattern according to the predetermined size and shape of bracelet 12 as discussed above.

Regardless of which process is used (i.e., the process shown in FIGS. 1 and 2 or the process shown in FIGS. 3 and 4), after lamination, the single substrate 36 may then be moved into die-cut stations 38 where the continuous substrate 36 may be die-cut to the shape and form of the bracelets 12 in a sheet or pattern configuration.

The bracelets 12, still held together on the substrate 36, are then moved into an RFID inspection station 40. The functionality and location of the RFID inlets 14 on the bracelets 12 are determined by the RFID inspection station 40 and compared with pre-determined criteria to determine if the RFID inlets 14 are positioned within tolerances of a predetermined position on the bracelets 12. Bracelets 12 with non-functional or badly positioned RFID inlets 14 are marked and separated from bracelets 12 with functional and correctly positioned RFID inlets 14 later in the process.

The bracelets 12 then move into a printing station 42 where indicia may be printed upon a surface of one or more bracelets 12. Information may also be electronically imparted to the RFID inlets 14 of one or more bracelets 12. Where prior art expedients are utilized, this entails the utilization of a suitable printer or other information imprinting device into which the bracelet 12 is introduced and the requisite information regarding a user, corporation, person or object is to be applied to a surface of the bracelet 12 or imparted into the RFID inlet 14. Decorative, as well as informative, indicia may also be printed on the bracelets 12.

From there, the bracelets 12 move to a sheeter 44 for cutting and stacking sheets of bracelets 12. The bracelets 12 are cut and sized into sheets, according to predetermined patterns 46 of various sizes and shapes. The patterns 46 of bracelet sheets are then stacked one atop the other at the end of the process. Alternatively, the bracelets 12 may be formed into a roll instead of being put through the sheeter 44.

By using a continuous source of pre-fabricated RFID inlets, the fabrication process is improved and inefficiencies during the manufacturing process reduced and/or eliminated. The use of pre-fabricated substrates allows replacement rolls of substrate to be quickly placed on the apparatus 10 once the old roll of substrate has been used up; allowing production to quickly resume once the replacement roll is in position. The use of a pre-fabricated RFID substrate 26 also minimizes the chances that overall production will be slowed down due to errors fabrication and/or placement of RFID circuitry as pre-fabricated rolls 24 of RFID substrate 26 may have already been inspected to ensure that the RFID inlets 14 are arranged and functioning properly.

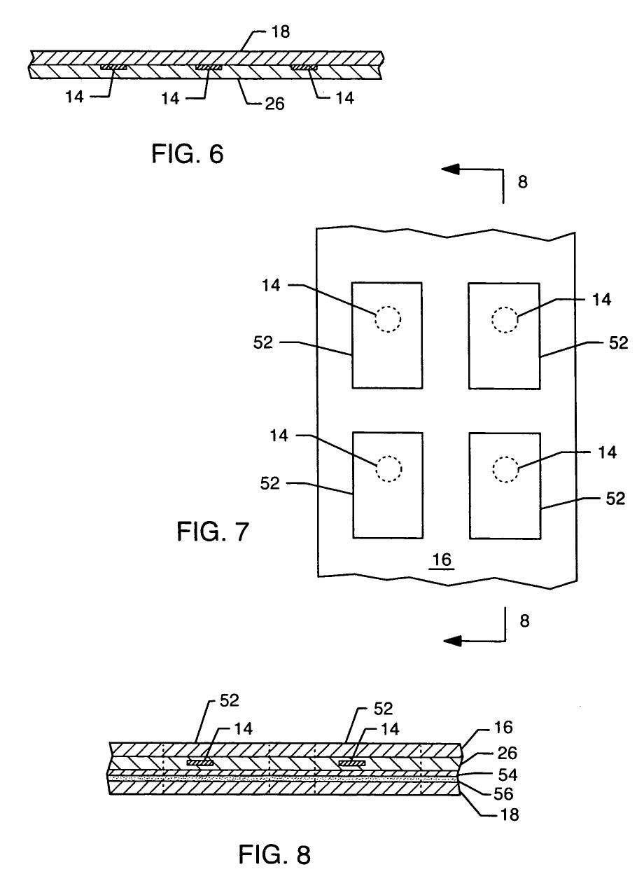

In another alternative, in order to reduce materials and cost, the top substrate 16 may be eliminated and the RFID substrate 26 used in its place as the top substrate, as seen in FIG. 6. The RFID inlets 14 may then be sandwiched between the RFID substrate 26 and the bottom substrate 18. This ensures a secure lamination and a thinner, more flexible band.

Additionally, the RFID antenna may be printed on the bottom substrate 18, if the RFID substrate 26 includes only RFID chips. In a further alternative, if only the top and bottom substrates 16, 18 are used, the RFID chip circuitry may be printed concurrently with the printing of the antenna, as outlined above. Organic circuits may be used when printing the RFID chip circuitry.

In an additional alternative, the above-described process may be used to produce tags in the form of labels 52 instead of bracelets 12, as shown in FIGS. 7 and 8. In this alternative, a substrate 26 of RFID inlets may be sandwiched between a top substrate 16 and a bottom substrate 18. In this situation, these substrates may be made of paper, writable plastic or the like. The labels 52 may be non-adhesive or the bottom of RFID substrate 26 may be at least partially covered by a layer of adhesive 54 while a top surface of the bottom substrate 18 may be at least partially covered by a silicone release layer 56 in the area around and near the labels 52 to make an adhesive label 52. The substrates 16, 26, 18 are laminated together and die-cut into labels. In a further alternative, holes may be die-cut into the bracelets 12 or labels 52 during the above-described processes so that a fastener, such as a clasp or the like, may be used to secure the bracelet 12 to a user's wrist or the like or secure the non-adhesive label 52 to something.

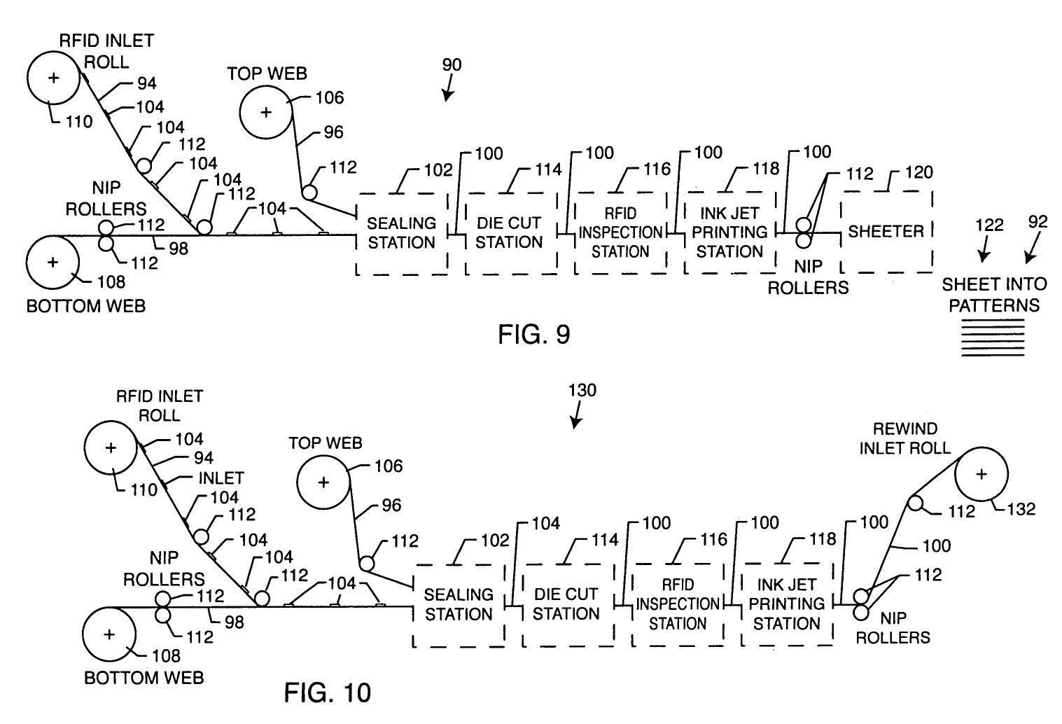

As illustrated in FIG. 9, in another embodiment of the present invention, a continuous lamination apparatus 90 incorporates a process that manufactures RFID tags on sheets or strips 92 by attaching together three substrates (i.e., an RFID inlet substrate 94, a top substrate 96, and a bottom substrate 98) as one continuous multi-layer substrate 100, either through a heat-sealing process using a heated die or by using an adhesive coating in a sealing station 102, such that the continuous multi-layer substrate 100 may be formed into a dispensing configuration in the form of a stack 122 where the continuous substrate 100 comprises a continuous stack of a plurality of strips or sheets 92. The RFID tags may be in various forms including, without limitation, bracelet(s) or label(s). The substrates 94, 96, 98 may be in various forms including, without limitation, sheets (rolled (shown) or stacked), strips (rolled (shown) or stacked) or the like.

The RFID inlet substrate 94 (including the RFID inlets 104) and the other substrates 96, 98 are shown following a generally lineal path through the apparatus 90. In the interests of space economy, a more circuitous path may be followed as required by geometry and placement of the elements of the apparatus 90. The RFID inlet 104 may be of a read only, read/write, a passive, or an active configuration. The substrates 94, 96, 98 may be made of an engineering thermoformed plastic in the form of respective stacks (not shown) or rolls 106, 108 of web material that may include polyester, a low-density polyethylene and the like. This process sandwiches the RFID inlet(s) 104 between the top and bottom substrates 96, 98 of web material. The RFID inlets 104 are pre-fabricated in a roll form 110 on the substrate 94.

As with the other embodiments, the roll 110 of RFID inlet substrate 94 is supplied having pre-arranged, pre-fabricated RFID inlets 104 arranged according to the predetermined size and shape of the tags, the length supplied as needed. Alternatively, the RFID inlet substrate 94 and substrates 96, 98 may be provided in a fan-folded stack or other configurations and dispensed from a suitable receptacle with the RFID inlet substrate 94 retaining the characteristic of pre-arranged, pre-fabricated RFID inlets 104. The pre-fabricated RFID inlets 104 are placed on the bottom substrate 98 in the pre-arranged pattern conforming to the predetermined size and shape of tag as discussed above.

Juxtaposed to the lineal path of the substrates 94, 96, 98 is a translating means (not shown). The translating means includes a number of nip or drive rollers 112 positioned along the apparatus 90 in order to move the substrates 94, 96, 98 along from station to station. These drive rollers 106 frictionally engage with the surfaces of the RFID inlet substrate 94, as well as the top and bottom substrates 96, 98, frictionally driving the substrates 94, 96, 98 through the apparatus 90. As outlined above, the substrates 94, 96, 98 may be in the form of strips, sheets or the like.

The drive roller 112 may be rotated by an electric motor or similar means, but it is preferable that a stepper motor or the like be utilized in the apparatus 90 because the process of the invention may require that the substrates 94, 96, 98 be halted intermittently.

The speed of the stepper motor may be regulated by suitable control means (not shown) in order to control the translation of the substrates 94, 96, 98 through the apparatus 90 and control the length of the dwell times necessitated by the process of the invention.

The process begins with the pre-fabricated roll 110 of RFID inlet substrate 94 having pre-arranged, pre-fabricated RFID inlets 104. The roll 110 may have repeated single or side-by-side multiples of RFID inlets 104 placed sequentially one-after-the-other. It is preferable that the RFID inlets 104 be arranged depending on the predetermined size and shape of the sheets 92. The length of roll 110 is then supplied as needed. Alternatively, the RFID inlet substrate 94 and substrates 96, 98 may be provided in a fan-folded stack or other configurations and dispensed from a suitable receptacle with the RFID inlet substrate 94 retaining the characteristic of pre-arranged, pre-fabricated RFID inlets 104. Alternatively, the RFID inlets 104 may be introduced without the substrate 94 and either hand or machine positioned on the bottom substrate 98.

The substrates 94, 96, 98 may be transparent, translucent, colored in solid colors or multi-color decorative patterns. For example, the RFID, top and bottom substrates 94, 96, 98 may be blue in color. In another example, one of the top and bottom substrates 96, 98 may be blue while the other substrate may be red and the RFID substrate 94 may be white to form a patriotic red, white and blue pattern. In yet another example, the substrates may be covered with holiday patterns (e.g., Christmas, Chanukah, Fourth of July, Halloween, etc.).

As mentioned above, this process sandwiches the RFID substrate 94 along with the RFID inlets 104 between the top and bottom substrates 96, 98 of web material in the sealing station 102 into the continuous substrate 100.

After lamination, the single substrate 100 will then be moved into a die-cut station 114 where the continuous substrate 100, which may be in the form of a continuous strip or a continuous sheet, may be die-cut to the shape and form of various tags including, but not limited to bracelets or labels. The continuous multi-layer substrate 100 may thus be separated into a plurality of discrete multi-layer sections of predetermined length and shape (e.g., strips, sheets or the like) which are still connected together as the continuous multi-layer substrate 100 but the die-cuts differentiate the discrete multi-layer sections that form the continuous substrate 100. As mentioned previously, the dispensed plurality of the RFID inlets 104 were dispensed sequentially and spaced apart based on the predetermined size and shape of the plurality of discrete multi-layer sections. In this manner, the discrete multi-layer sections die-cut into tags are arranged end-to-end. When the plurality of discrete multi-layer sections are die-cut so as to comprise at least two pairs of discrete multi-layer sections in parallel, the pairs of discrete multi-layer sections may be arranged end-to-end. The die-cuts in the continuous multi-layer substrate 100 thus allow the continuous substrate 100 to be separated into the plurality of discrete multi-layer sections. Each of the multi-layer substrates formed from the continuous substrate 100 may include a removable layer, especially if the tag formed into the continuous substrate 100 is intended to be a bracelet or label with an adhesive surface.

The process may be adjusted so that the die-cut station 114 remains inactive and the continuous substrate 100 passes through the station 114 without being die-cut so that the substrate 100 remains in an unseparated condition, allowing the continuous substrate 100 to be differentiated into bracelets, labels or the like at a later time by the end-user, as described in more detail below.

The bracelets or labels, still held together on the substrate 100, are then moved into an RFID inspection station 116. The functionality and location of the RFID inlets 104 on the bracelets or labels of the continuous substrate 100 are determined by the RFID inspection station 116 and compared with pre-determined criteria to determine if the RFID inlets 104 are positioned within tolerances of a predetermined position on the substrate 100 or the bracelets and/or labels of the continuous substrate 100. Non-functional or badly positioned RFID inlets 104 are marked and separated from the continuous substrate 100 later in the process. Also, if the substrate 100 is separated into bracelets and/or labels, non-functional or badly positioned RFID inlets 104 are marked and separated from the bracelets and/or labels with functional and correctly positioned RFID inlets 104 later in the process.

The continuous substrate 100 then moves into a printing station 118 where indicia may be printed upon a surface of the continuous substrate 100 of one or more bracelets and/or labels of the continuous substrate 100. Information may also be electronically imparted to the RFID inlets 104. Where prior art expedients are utilized, this entails the utilization of a suitable printer or other information imprinting device into which the substrate 100 is introduced and the requisite information regarding a user, corporation, person or object is to be applied to a surface of the continuous substrate 100 or imparted into the RFID inlet. Decorative, as well as informative, indicia may also be printed on the continuous substrate 100.

From there, the continuous substrate 100 moves to a sheeter 120 for cutting and stacking of the continuous substrate 100 into a stack of strips or sheets. The continuous substrate 100 is cut and sized into strips or sheets, according to predetermined patterns 122 of predetermined sizes and shapes. The patterns 122 of the strips or sheets 92 are then stacked one atop the other at the end of the process. The stack of may be comprised of individual strips or sheets 92 placed one atop the other or the stack may be fan-folded with the strips or sheets 92 attached to an adjoining strip or sheet 92 at one end.

FIG. 10 illustrates another embodiment of the present invention, similar to the process and apparatus 90 of FIG. 9 above, in which a continuous lamination apparatus 130 incorporates a process that manufactures RFID tags on sheet(s) or strips 92 by attaching together the three substrates (i.e., the RFID inlet substrate 94, the top substrate 96, and the bottom substrate 98) as one continuous multi-layer substrate 100, either through a heat-sealing process using a heated die or by using an adhesive coating in a sealing station 102, such that the continuous multi-layer substrate 100 may be formed into a dispensing configuration in the form of a roll 132 where the continuous substrate 100 comprises a continuous roll of a plurality of strips or sheets 92. The RFID tags may be in various forms including, without limitation, bracelet(s) or label(s).

Unlike the process described above with respect to FIG. 9, once the continuous substrate has passed through the ink jet printing station 118 in the process of FIG. 10, the continuous substrate 100 including the RFID inlets 104 is formed into the dispensing configuration in the form of a roll 132 by winding the continuous substrate such that if forms a continuous roll of a plurality of strips or sheets 92.

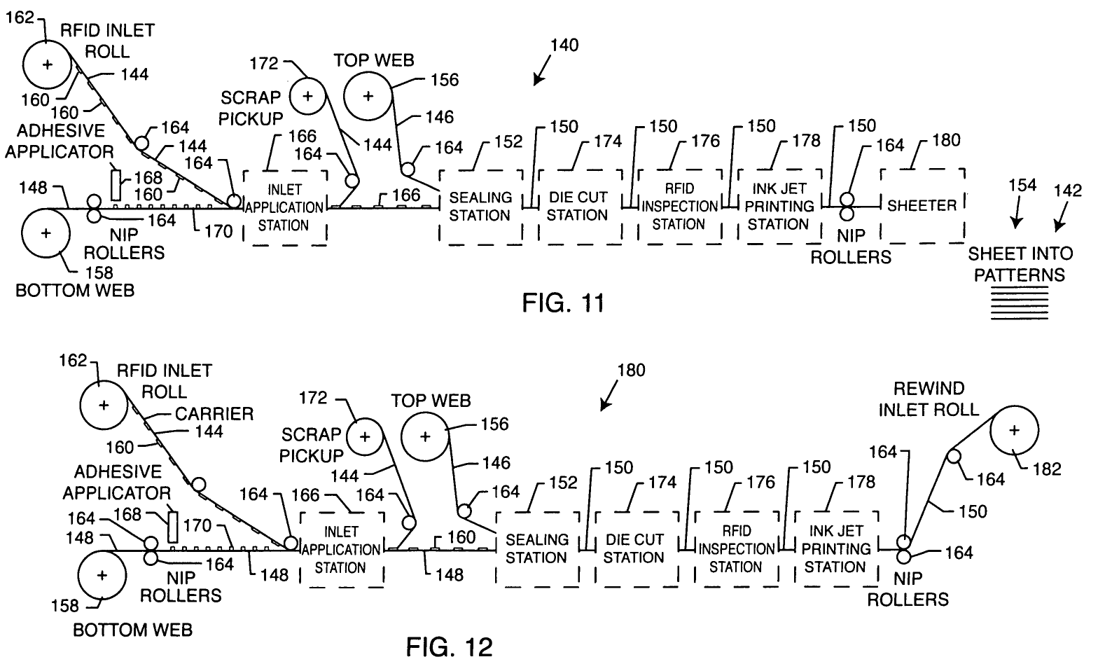

As illustrated in FIG. 11, in an additional embodiment of the present invention, a continuous lamination apparatus 140 incorporates a process that manufactures RFID tags on sheet(s) or strips 142 by attaching together three substrates (i.e., an RFID inlet substrate 144, a top substrate 146, and a bottom substrate 148) as one continuous multi-layer substrate 150, either through a heat-sealing process using a heated die or by using an adhesive coating in a sealing station 152, such that the continuous multi-layer substrate 100 may be formed into a dispensing configuration in the form of a stack 154 where the continuous substrate 150 comprises a continuous stack of a plurality of strips or sheets 142. The RFID tags may be in various forms including, without limitation, bracelet(s) or label(s). The substrates 144, 146, 148 may be in various forms including, without limitation, sheets (rolled (shown) or stacked), strips (rolled (shown) or stacked) or the like.

The RFID inlets 160 are pre-fabricated in a roll form 162 on the substrate 144. As outlined above, the substrates 144, 146, 148 may be in the form of rolled strips or sheets. As with the other embodiments, the RFID inlets 160 are pre-arranged and pre-fabricated in a roll form 162 on a substrate 144. The RFID inlets 160 are pre-arranged on the substrate 144 according to a predetermined size and shape of tag and pattern of dispensing, i.e., single, pairs, quads, end-to-end, parallel, etc. The pre-arrangement of the RFID inlets 160 on the substrate 144 controls the pattern in which the RFID inlets 160 are placed between the substrates 146, 148, thereby eliminating the need to align and/or register the RFID inlet 160 with a pattern or indicia on the substrates 146, 148.

The RFID inlet substrate 144 (including the RFID inlets 160) and the other substrates 146, 148 are shown following a generally lineal path through the apparatus 140. In the interests of space economy, a more circuitous path may be followed as required by geometry and placement of the elements of the apparatus 140. The RFID inlet 160 may be of a read only, read/write, a passive, or an active configuration. The substrates 146, 148 may be made of an engineering thermoformed plastic in the form of respective stacks (not shown) or rolls 156, 158 of web material that may include polyester, a low-density polyethylene and the like. This process sandwiches the RFID inlet substrate 144 including the RFID inlet(s) 160 between the top and bottom substrates 146, 148 of web material.

Juxtaposed to the lineal path of the substrates 144, 146, 148 is a translating means (not shown). The translating means includes a number of nip or drive rollers 164 positioned along the apparatus 140 in order to move the substrates 144, 146, 148 along from station to station. These drive rollers 164 frictionally engage with the surfaces of the RFID inlet substrate 144, as well as the top and bottom substrates 146, 148, frictionally driving the substrates 144, 146, 148 through the apparatus 140.

The drive roller 164 may be rotated by an electric motor or similar means, but it is preferable that a stepper motor or the like be utilized in the apparatus 140 because the process of the invention may require that the substrates 144, 146, 148 be halted intermittently.

The speed of the stepper motor may be regulated by suitable control means (not shown) in order to control the translation of the substrates 144, 146, 148 through the apparatus 140 and control the length of the dwell times necessitated by the process of the invention.

The process begins with the pre-fabricated roll 162 of RFID inlet(s) 160. The roll 162 may have repeated single or side-by-side multiples of RFID inlets 160 placed sequentially one-after-the-other. However, as discussed above, the RFID inlets 160 are spaced apart depending on the desired length and width of the RFID strip(s) or sheet(s) 142. The length of the roll 162 is then supplied as needed. Alternatively, the RFID inlets 160 and substrates 148, 148 may be provided in fan-folded or other configurations and dispensed from a suitable receptacle with the RFID inlet substrate 144 retaining the characteristic of pre-arranged, pre-fabricated RFID inlets 160.

The top and bottom substrates 146, 148 may be transparent, translucent, colored in solid colors or multi-color decorative patterns. For example, the top and bottom substrates 146, 148 may be blue in color. In another example, one of the substrates 146, 148 may be blue while the other substrate 146, 148 may be red. In yet another example, the substrates 146, 148 may be covered with holiday patterns (e.g., Christmas, Chanukah, Fourth of July, Halloween, etc.). Alternatively, the RFID inlets 160 may be introduced without the substrate 144 and either hand or machine positioned on the bottom substrate 148.

Alternatively, an inlet dispenser/application station 166 may accommodate the substrate 144 holding the RFID inlets 160 and the bottom substrate 148. The inlet dispenser station 166 may remove an RFID inlet 160 from the substrate 144 and place the RFID inlet 160 on a top surface of the bottom substrate 148. Such removal may be performed mechanically or through physical force exerted by an adhesive or similar material on the surface of the substrate 148 as follows. Prior to the bottom substrate 148 entering the inlet dispenser/application station 166, an adhesive applicator 168 may place a portion of adhesive 170 on the top surface of the bottom substrate 148 in an area in which the RFID inlet 160 is intended to be placed so as to secure the RFID inlet 160 to the surface of the bottom substrate 148 when the RFID inlet 160 is placed on top of the adhesive 170. Alternatively, the adhesive 170 may be applied generally to the top surface of the bottom substrate 148 so as to eliminate the need to coordinate the timing and indexing of the placement of the RFID inlets 160 with the timing and indexing of the placement of the adhesive 170 by the adhesive applicator 168.

A takeup roll 172 may be used to collect the substrate 144 from which the RFID inlets 160 have been removed. The bottom substrate 148, now including the RFID inlets 160, is then moved into the sealing station 152. The top substrate 146 is also moved into the sealing station 152. The top and bottom substrates 146, 148 may then be laminated or sealed together as one continuous substrate 150, either through a heat-sealing process using a heated die or by using an adhesive coating. This process sandwiches the RFID inlets 160 between the top and bottom substrates 146, 148 of web material, creating the continuous substrate 150.

After lamination, the continuous substrate 150 may be moved into a die-cut station 174 where the continuous substrate 150, which may be in the form of a continuous strip or a continuous sheet, may be die-cut to the shape and form of various tags including, but not limited to bracelets or labels. The continuous multi-layer substrate 150 may thus be separated into a plurality of discrete multi-layer sections of predetermined length and shape (e.g., strips, sheets or the like) which are still connected together as the continuous multi-layer substrate 150 but the die-cuts differentiate the discrete multi-layer sections that form the continuous substrate 150. The previously dispensed plurality of the RFID inlets 160 were dispensed sequentially and spaced apart based on the predetermined length and shape of the plurality of discrete multi-layer sections. In this manner, the discrete multi-layer sections die-cut into tags may be arranged end-to-end. When the plurality of discrete multi-layer sections are die-cut so as to comprise at least two pairs of discrete multi-layer sections in parallel, the pairs of discrete multi-layer sections may be arranged end-to-end. The die-cuts in the continuous multi-layer substrate 150 thus allow the continuous substrate 150 to be separated into the plurality of discrete multi-layer sections. Each of the discrete multi-layer sections formed from the continuous substrate 150 may include a removable layer, especially if the tag formed into the continuous substrate 150 is intended to be a bracelet or label with an adhesive surface.

The process may be adjusted so that the die-cut station 174 remains inactive and the continuous substrate 150 passes through the station 174 without being die-cut so that the continuous substrate 150 remains in an unseparated condition, so that the continuous substrate 150 may be differentiated into bracelets, labels or the like at a later time by the end-user, as described in more detail below.

The bracelets or labels, still held together on the substrate 150, are then moved into an RFID inspection station 176. The functionality and location of the RFID inlets 160 on the bracelets or labels of the continuous substrate 150 are determined by the RFID inspection station 176 and compared with pre-determined criteria to determine if the RFID inlets 160 are positioned within tolerances of a predetermined position on the substrate 150 or the bracelets and/or labels of the continuous substrate 150. Non-functional or badly positioned RFID inlets 160 are marked and separated from the continuous substrate 150 later in the process. Also, if the substrate 150 is separated into bracelets and/or labels, non-functional or badly positioned RFID inlets 160 are marked and separated from the bracelets and/or labels with functional and correctly positioned RFID inlets 160 later in the process.

The continuous substrate 150 then moves into a printing station 178 where indicia may be printed upon a surface of the continuous substrate 150 or one or more bracelets and/or labels of the continuous substrate 150. Information may also be electronically imparted to the RFID inlets 160. Where prior art expedients are utilized, this entails the utilization of a suitable printer or other information imprinting device into which the substrate 150 is introduced and the requisite information regarding a user, corporation, person or object is to be applied to a surface of the continuous substrate 150 or imparted into the RFID inlet. Decorative, as well as informative, indicia may also be printed on the continuous substrate 150.

From there, the continuous substrate 150 moves to a sheeter 180 for cutting and stacking of the continuous substrate 150 into a stack of strips or sheets according to predetermined patterns 142 of predetermined sizes and shapes. The strips or sheets 142 are then stacked one atop the other at the end of the process. The stack of may be comprised of individual strips or sheets 142 placed one atop the other or the stack may be fan-folded with the strips or sheets 142 attached to an adjoining strip or sheet 142 at one end.

FIG. 12 illustrates a further embodiment of the present invention, similar to the process and apparatus 140 of FIG. 11 above, in which a continuous lamination apparatus 180 incorporates a process that manufactures RFID tags on sheet(s) or strips 142 by attaching together the top and bottom substrates 146, 148, with RFID inlets 160 positioned therebetween, as one continuous multi-layer substrate 150, either through a heat-sealing process using a heated die or by using an adhesive coating in the sealing station 152, such that the continuous multi-layer substrate 150 may be formed into a dispensing configuration in the form of a roll 182 where the continuous substrate 150 comprises a continuous roll of a plurality of strips or sheets 142. The RFID tags may be in various forms including, without limitation, bracelet(s) or label(s).

Unlike the process described above with respect to FIG. 11, once the continuous substrate has passed through the ink jet printing station 178, the continuous substrate 150 including the RFID inlets 160 is formed into the dispensing configuration in the form of a roll 182 by winding the continuous substrate 150 such that if forms a continuous roll of a plurality of strips or sheets 142.

As mentioned above, the continuous substrate 100, 150 may remain unseparated regardless of which process (FIGS. 9-12) is used to manufacture the continuous substrate 100, 150 to result in a dispensing configuration of stacked strips or sheets 92, 142 or rolled strips or sheets 132, 182 that may then be formed into bracelets, labels or the like by an end-user. For example, in one embodiment where the dispensing configuration is a roll, the roll comprises a continuous roll of a plurality of strips or sheets. Each of the plurality of strips or sheets in the continuous roll corresponds to one of the plurality of discrete multi-layer sections. Each discrete section may comprise at least one bracelet and may further include at least two pairs of parallel bracelets which may be arranged end-to-end. Each discrete section may also comprise at least one label and may include at least two pairs of parallel labels which may be arranged end-to-end. Likewise, in an example of one embodiment where the dispensing configuration comprises a stack (i.e., a stack which may or may not comprise a fan-folded stack), the stack comprises a continuous stack of a plurality of strips or sheets. Each of the plurality of strips or sheets in the continuous stack corresponds to one of the plurality of discrete multi-layer sections. Each discrete section comprises at least one bracelet and may further include at least two pairs of parallel bracelets which may be arranged end-to-end. Each discrete section may also comprises at least one label and may further include at least two pairs of parallel labels which may be arranged end-to-end.

By using a continuous source of pre-fabricated RFID inlets, the fabrication process is improved and inefficiencies during the manufacturing process reduced and/or eliminated. The use of pre-fabricated substrates alone allows replacement rolls of substrate to quickly be placed on the apparatus 10 once the old roll of substrate has been used up; allowing production to quickly resume once the replacement roll is in position. The use of a pre-fabricated RFID substrate also minimizes the chances that overall production will be slowed down due to errors in RFID circuitry as pre-fabricated rolls of RFID substrate may have already been inspected to ensure that the RFID inlets are functioning properly.

In another alternative, in order to reduce materials and cost, the top substrate 96, 146 may be eliminated and the RFID substrate 94, 144 used in its place as the top substrate, as seen in FIG. 6. The RFID inlets 104, 160 may then be sandwiched between the RFID substrate 94, 144 and the bottom substrate 98, 148. This ensures a secure lamination and a thinner, more flexible band. Additionally, the RFID antenna may be printed on the bottom substrate 98, 148 if the RFID substrate 94, 144 includes only RFID chips. In a further alternative, if only the top 96, 146 and bottom substrates 98, 148 are used, the RFID chip circuitry may be printed concurrently with the printing of the antenna, as outlined above. Organic circuits may be used when printing the RFID chip circuitry.

Consequently, by the practice of the processes described above, many of the problems inherent in present day identification bracelet supply are eliminated, with consequent economies in the supply of the bracelets resulting from the processes described above and the elimination of unnecessary expenditures of time and energy incident to the utilization of conventional identification bracelets.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

1. A process for continuous lamination of radio frequency identification (RFID) tags, comprising the steps of:
providing a continuous source of substrate having RFID inlets in a pre-arranged pattern;
dispensing the RFID inlets in the pre-arranged pattern between top and bottom substrates of web material;
attaching the top and bottom substrates to form a continuous multi-layer substrate; and
forming the continuous multi-layer substrate into a dispensing configuration.

2. The process of claim 1, further comprising the steps of separating the continuous multi-layer substrate into a plurality of discrete multi-layer sections based upon a predetermined length and shape of the tags, and forming the plurality of discrete multi-layer sections into the dispensing configuration.

3. The process of claim 1, wherein the pre-arranged pattern of RFID inlets is based on a predetermined length and shape of the tags.

4. The process of claim 2, wherein each discrete multi-layer section includes a removable layer.

5. The process of claim 1, wherein at least a pair of the RFID inlets are dispensed in parallel.

6. The process of claim 1, wherein dispensing the RFID inlets between the top and bottom substrate web materials includes dispensing the continuous source of substrate between the top and bottom substrate web materials along with the RFID inlets.

7. The process of claim 1, including the step of placing an adhesive coating on at least one of the top and bottom substrates, and placing the RFID inlets on the adhesive coating.

8. The process of claim 2, wherein each discrete multi-layer section comprises at least one bracelet.

9. The process of claim 8, wherein each discrete multi-layer section includes at least two pairs of parallel bracelets.

10. The process of claim 9, wherein the pairs of parallel bracelets are arranged end-to-end.

11. The process of claim 2, wherein each discrete multi-layer section comprises at least one label.

12. The process of claim 11, wherein each discrete multi-layer section includes at least two pairs of parallel labels.

13. The process of claim 12, wherein the pairs of parallel labels are arranged end-to-end.

14. The process of claim 2, wherein the dispensing configuration comprises a roll.

15. The process of claim 14, wherein the roll comprises a rolled continuous roll of a plurality of strips, each strip corresponding to one of the discrete multi-layer sections.

16. The process of claim 14, wherein the roll comprises a continuous roll of a plurality of sheets, each sheet corresponding to one of the discrete multi-layer sections.

17. The process of claim 2, wherein the dispensing configuration comprises a stack.

18. The process of claim 17, wherein the stack comprises a fan-folded stack.

19. The process of claim 18, wherein the stack comprises a continuous stack of a plurality of strips, each strip corresponding to one of the discrete multi-layer sections.

20. The process of claim 17, wherein the stack comprises a continuous stack of a plurality of sheets, each sheet corresponding to one of the discrete multi-layer sections.

21. A process for continuous lamination of radio frequency identification (RFID) tags, comprising the steps of:
providing a continuous source of substrate having RFID inlets in a pre-arranged pattern based on a predetermined length and shape of the tags;
dispensing the continuous source of substrate having RFID inlets in the pre-arranged pattern between top and bottom substrates of web material;
attaching the top and bottom substrates to form a continuous multi-layer substrate; and
forming the continuous multi-layer substrate into a dispensing configuration.

22. The process of claim 21, further comprising the steps of separating the continuous multi-layer substrate into a plurality of discrete multi-layer sections based upon the predetermined length and shape of the tags, and forming the plurality of discrete multi-layer sections into the dispensing configuration.

23. The process of claim 22, wherein each discrete multi-layer section includes a removable layer.

24. The process of claim 21, wherein at least a pair of the RFID inlets are dispensed in parallel.

25. The process of claim 21, including the step of placing an adhesive coating on at least one of the top and bottom substrates, and placing the RFID inlets on the adhesive coating.

26. The process of claim 22, wherein each discrete multi-layer section comprises at least one bracelet.

27. The process of claim 26, wherein each discrete multi-layer section includes at least two pairs of parallel bracelets.

28. The process of claim 27, wherein the pairs of parallel bracelets are arranged end-to-end.

29. The process of claim 22, wherein each discrete multi-layer section comprises at least one label.

30. The process of claim 29, wherein each discrete multi-layer section includes at least two pairs of parallel labels.

31. The process of claim 30, wherein the pairs of parallel labels are arranged end-to-end.

32. The process of claim 22, wherein the dispensing configuration comprises a roll.

33. The process of claim 32, wherein the roll comprises a rolled continuous roll of a plurality of strips, each strip corresponding to one of the discrete multi-layer sections.

34. The process of claim 32, wherein the roll comprises a continuous roll of a plurality of sheets, each sheet corresponding to one of the discrete multi-layer sections.

35. The process of claim 22, wherein the dispensing configuration comprises a stack.

36. The process of claim 35, wherein the stack comprises a fan-folded stack.

37. The process of claim 36, wherein the stack comprises a continuous stack of a plurality of strips, each strip corresponding to one of the discrete multi-layer sections.

38. The process of claim 35, wherein the stack comprises a continuous stack of a plurality of sheets, each sheet corresponding to one of the discrete multi-layer sections.
